(19) United States
(12) Patent Application Publication
(10) Pub. No.: US 2006/0168644 A1
(43) Pub. Date: Jul. 27, 2006

(54) RFID tag with embedded Internet address

(75) Inventors: Clark Adam Richter, St. Louis, MO (US); Steven J. Winter, Arlington, WA (US)

Correspondence Address: Brian M. Berliner;O'MELVENY & MYERS LLP, 400 South Hope Street, Los Angeles, CA, 90071-2899, US

(73) Assignee: INTERMEC IP CORP.

(21) Appl. No.: 11/299,174

(22) Filed: Dec. 9, 2005

Related U.S. Application Data
(63) Continuation-in-part of application No. 09/515,297, filed on Feb. 29, 2000, now abandoned.

(51) Int. Cl. H04L 9/32

(52) U.S. Cl. 726/2

(57) ABSTRACT

A radio frequency identification (RFID) transponder comprises a memory space having a predetermined data field for storing a destination address identifying a location on the Internet corresponding to the RFID transponder. The Internet address may further comprise an e-mail address or Uniform Resource Locator (URL). In an embodiment of the invention, a computer network comprises a client computer having an application executing thereon, an RFID tag having a memory containing an Internet address corresponding to the RFID tag, and an RFID reader connected to the client computer and adapted to communicate with the RFID tag. The RFID reader recovers the Internet address from the RFID tag and provides the Internet address to the client computer. The client computer thereby communicates with the location defined by the Internet address corresponding to the RFID tag using the application. A host server is connected to the client computer, and may be further connected to the Internet. The client computer thereby can access the Internet location by operation of the application through the host server.

### RELATED APPLICATION

This application is a continuation-in-part of co-pending application Ser. No. 09/515,297, filed Feb. 29, 2000, which application is incorporated herein, in its entirety, by reference.

### BACKGROUND OF THE INVENTION

1. Field of the Invention

The present invention relates to automated data collection systems that collect information from radio frequency identification (RFID) transponders, and more particularly, to an automated data collection system that uses an imbedded Internet address to facilitate communication of information regarding the RFID tag to a location on the Internet.

2. Description of Related Art

In the automatic data identification industry, the use of RFID transponders (also known as RFID tags) has grown in prominence as a way to track data regarding an object to which the RFID transponder is affixed. An RFID transponder generally includes a semiconductor memory in which digital information may be stored, such as an electrically erasable, programmable read-only memory (EEPROMs) or similar electronic memory device. Under a technique referred to as “backscatter modulation.” the RFID transponders transmit stored data by reflecting varying amounts of an electromagnetic field provided by an RFID interrogator by modulating their antenna matching impedances. The RFID transponders can therefore operate independently of the frequency of the energizing field, and as a result, the interrogator may operate at multiple frequencies so as to avoid radio frequency (RF) interference, such as utilizing frequency hopping spread spectrum modulation techniques. The RFID transponders may either extract their power from the electromagnetic field provided by the interrogator, or include their own power source.

Since RFID transponders do not include a radio transceiver, they can be manufactured in very small, lightweight and inexpensive units. RFID transponders that extract their power from the interrogating field are particularly cost effective since they lack a power source. In view of these advantages, RFID transponders can be used in many types of applications in which it is desirable to track information regarding an object. One such application is to include RFID transponders in labels affixed to manufactured goods, packages or other such objects. The RFID transponders would contain stored data regarding the objects, such as the customer information, product specifications, serial numbers, shipping requirements, etc. A handheld or fixed position RFID interrogator can interrogate the RFID transponder in order to recover the stored data. The RFID interrogator may then communicate the collected data to a computer or computer network for further processing by a particular software application.

Despite the advantages of RFID transponders, there is an inherent limitation in the amount of information that can be stored in the memory of an RFID transponder. At the same time, there is an almost limitless capacity for storage of data files and applications on a network. Such networks may include a local area network (LAN), a wireless local area network (WLAN) or a wide area network (WAN), or may further comprise the Internet or a corporate intranet. As known in the art, the Internet is made up of more than 100,000 interconnected computer networks spread across over one hundred countries, including commercial, academic and governmental networks. Businesses and other entities have adopted the Internet as a model for their internal networks, or so-called “intranets.” Discrete locations within servers connected to the network are identified using an address. One portion of the Internet known as the World Wide Web includes graphical information stored and accessed in the form of so-called web pages, with each such web page having a unique address referred to as a Uniform Resource Locator (URL). Another portion of the Internet is used to communicate electronic mail (or e-mail) messages, with individual users being assigned unique e-mail addresses. There presently exists no efficient way to link information regarding an RFID transponder to a corresponding location on the Internet, such as to supplement the limited storage capacity of the RFID transponder with the enormous storage capability of a network.

Another drawback of conventional automated data collection systems is that the conveyance of information from the RFID interrogator to the software application operating on a computer or computer network is independent of the information content. The interrogator generally forwards the collected information to a software application irrespective of the content of the information, and the software application then determines what actions to take with respect to the information. There presently exist many known RFID transponder types having unique data formats and protocols, with each such format and protocol being generally incompatible with each other. More than one type of RFID transponder may be present within the operating environment of a single RFID interrogator, such as a first type of RFID transponder disposed on a truck and a second type of RFID transponder disposed on a pallet carried by the truck. Thus, separate software applications may be used to process the information from each of the RFID transponder types, and yet another software application may be used to distinguish between the collected information and route the information to the appropriate software application for subsequent processing. The use of a software application to provide the routing function necessarily limits the flexibility of the network applications that use the collected information.

It would therefore be desirable to provide an automated data collection system in which the RFID transponder can identify or communicate with a particular location on a network by designating its associated address. It would be further desirable to include information or applications relating to an RFID transponder on the network at the location designated by the address embedded in the RFID transponder.

### SUMMARY OF THE INVENTION

The present invention is directed to an RFID transponder comprising a memory space having a predetermined data field for storing a destination address identifying a location on a network, such as the Internet. The destination address may further comprises a Uniform Resource Locator (URL) defining the location of a web site associated with the RFID transponder, or an e-mail address for an entity associated with the RFID transponder.

In an embodiment of the invention, a computer network comprises a client computer having a browser application executing thereon, an RFID tag having a memory containing a network address corresponding to the RFID tag, and an RFID reader connected to the client computer and being adapted to communicate with the RFID tag. The RFID reader provides the network address recovered from the RFID tag to the client computer. The client computer thereby communicates with the location on the network corresponding to the RFID tag using an application, such as a web browser or e-mail client. A host server is connected to the client computer, and may be further connected to the Internet. The client computer thereby can access the location on the network by operation of the application through the host server to communicate information or execute applications.

In another embodiment of the invention, a method for reading an RFID tag comprises interrogating the RFID tag, receiving information stored in memory of the RFID tag including a network address identifying a location on a network corresponding to the RFID tag, and communicating with the location identified by the network address. The destination address may further comprise a Uniform Resource Locator or e-mail address. The method further comprises executing an application associated with the location, such as a Internet browser, e-mail client, Java-applet. It should be apparent that a single application operating from a network location may therefore be configured to process information and communicate with RFID tags in different remote locations. System configuration and maintenance may therefore readily performed from a centralized location, without updating remotely-installed software or firmware for communicating with RFID tags. Likewise, a single system of distributed RFID readers may be used to operate multiple different tracking or supply systems, merely by providing RFID tags containing separate network addresses for each of the multiple systems.

In a supply-chain embodiment of the invention, RFID tags are attached to items being transported in the supply chain. The RFID tags are automatically read at different locations in the supply chain by a system of distributed RFID readers to obtain Item-Time-Location-Status (ITLS) information about transported items. Each RFID reader obtains a network address, such as an Internet address, from responsive RID tags and provides ITLS information to the network location using a predetermined protocol. In the alternative, the reader may communicate with the network location using a protocol specified by a code on the RFID tag. Information carried by the RFID tag or information communicated to the or from the network location may be encrypted using a private key stored on the RFID tag.

To optimize operation of a logistical supply chain, it may be desirable to change information attributed to items in transit, including but not limited to destination, route, transportation mode, transportation charges, shipping account, warehouse locations, storage conditions, and so forth. For example, packages may be individually re-routed by updating destination information at any time during transit. Destination information may be updated and stored at a network location only, on individual RFID tags, or both. For further example, payment status may change depending on the location or status of the item in transit. Automatic payment of shipping or storage fees may be executed at the time a package is delivered, shipped, placed into storage, or released from storage, and a payment status associated with an item updated accordingly.

In an embodiment of the invention, RFID tags in a distributed system are configured to record one or more items of environmental data registered by a sensor attached to the package or located in the package environment and in communication with the RFID tag. For example, environmental data may include temperature, humidity, acceleration, and other factors as further described in U.S. Pat. No. 6,294,996 “RFID Tag Having Timing and Environmental Modules,” such as may be used to evaluate compliance with storage or other environmental requirements for an item in transit. Environmental data may be processed and recorded by a system application at a centralized location. In the alternative, or in addition, environmental data may be recorded in an RFID tag provided with a non-volatile memory. If environmental requirements are not complied with for a particular item, an alert may be automatically provided to designated recipients. Items in transit may then be disposed of according to a predetermined procedure, or according to instructions from an authorized party receiving an environmental alert.

A more complete understanding of the RFID tag having an embedded Internet address will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a block diagram illustrating a computer network having RFID readers arranged to read data from RFID transponders.

FIG. 2 is a block diagram of an exemplary RFID transponder.

FIG. 3 is a flow chart illustrating operation of an RFID reader.

FIG. 4 is a block diagram showing an RFID system according to alternative embodiments of the invention including multiple network addresses or environmental sensors.

FIG. 5A is a flow chart showing exemplary steps of a method for automatically updating information in a supply chain using RFID tags with embedded network address to track packages.

FIG. 5B is a flow chart illustrating exemplary steps of a method for automatic billing or payment in a supply chain using RFID tags with embedded network address.

FIG. 5C is a flow chart illustrating exemplary steps of a method for environmental sensing and recording in a supply chain using RFID tags with embedded network address.

### DETAILED DESCRIPTION OF THE PREFERRED EMBODIMENT

The present invention satisfies the need for an automated data collection system in which the RFID transponder has an embedded address to facilitate communication with a location on a network such as the Internet. In the detailed description that follows, like element numerals are used to describe like elements illustrated in one or more of the figures.

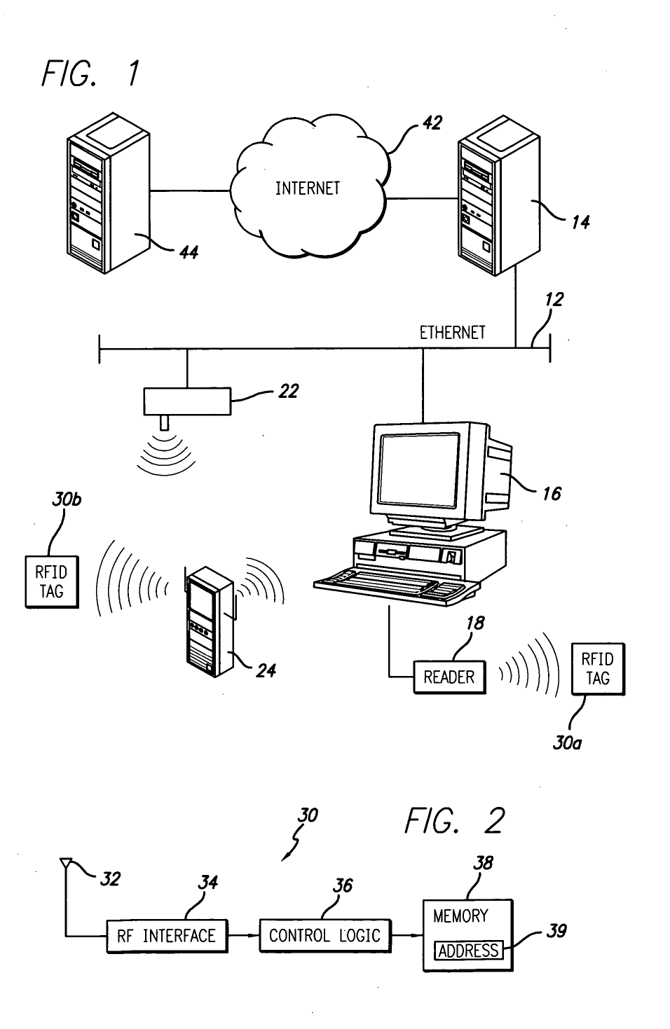

Referring first to FIG. 1, an automated data collection environment is illustrated that includes a computer system forming part of a local area network (LAN) or wide area network (WAN). The computer system includes a host server computer 14 attached to a network 12, and has plural client computers such as personal computer (PC) 16 connected to the host server computer through the network. As known in the art, the computers attached to the network 12 may communicate using various protocols, such as Ethernet. The host server computer 14 may comprise a high-speed microcomputer, minicomputer or mainframe computer that acts as a conduit for communication of data packets between the client computer 16 and the outside world. It should be appreciated that a large number of client computers may be coupled to the server computer 14 through the network 12. The host server computer 14 may also provide various system applications for the client computers, such as e-mail, file management, database, word processing, etc. The exemplary client computer 16 typically comprises a processor and non-volatile data storage device, such as a hard disk drive, optical disk drive, and the like. As used herein, the term “processor” is intended to broadly encompass microprocessors, digital signal processors (DSPs), application specific integrated circuits (ASICs), field programmable gate arrays (FPGAs), and the like. A user can enter commands and information into the client computer 16 through input devices such as a keyboard, mouse, microphone, joystick, game pad, scanner, etc. A video monitor or other visual display device coupled to the client computer 16 provides visual output to the user. Other output devices coupled to the client computer 16 may include printers, speakers, scanners, external data storage, etc.

The host server computer 14 may also be coupled to the Internet 42. As shown in FIG. 1, a remote server 44 is also coupled to the Internet. The remote server 44 may also have client computers (not shown) connected thereto, thereby permitting the routing of messages between end users connected to the respective client computers. The remote server 44 may also provide other applications, such as hosting a web site. The client computer 16 may include a browser application that enables the user to view graphical information communicated across the computer network, including web pages that are stored on the remote server 44, such as Netscape Navigator® from Netscape Communications Corp. or Internet Explorer® from Microsoft Corp. The client computer 16 may also include an e-mail client, such as Outlook® from Microsoft Corp.

The client computer 16 is further connected to an RFID reader 18 adapted to read encoded data stored in RFID tags, such as RFID tag 30a. The RFID reader 18 may have a hard-wired link to the client computer 16, or alternatively, may communicate over an RF or optical data link to the client computer or the network 12. Also, the RFID reader 18 may be mounted in a fixed location with respect to moving RFID tags, such as above a conveyor belt, or alternatively, the RFID reader may be manipulated by a user by hand into proximity with the RFID tags. As known in the art, the RFID reader 18 communicates with the RFID tag 30a using RF signals. An example of an RFID reader is provided by U.S. patent application Ser. No. 09/153,617, filed Sep. 15, 1998, entitled “Radio Frequency Identification Interrogator Signal Processing System For Reading Moving Transponders,” the subject matter of which is incorporated by reference herein in its entirety.

The host server computer 14 may further communicate with plural wireless devices, such as the handheld scanning terminal 24, through an RF access point 22. The RF access point 22 is connected directly to the network 12, and extends the range of the network to include a wireless local area network (WLAN). The handheld scanning terminal 24 may be adapted to perform computing and communicating functions, and comprises a processor, non-volatile data storage device (e.g., hard disk drive or flash memory), an input device (e.g., keyboard or touchpad) and a display (e.g., liquid crystal display (LCD)), as in the client computer 16. The handheld scanning terminal 24 may be adapted to execute many of the software applications that would ordinarily operate on a full-size personal computer, including a web browser application. In a preferred embodiment of the present invention, the scanning terminal 24 further includes an integrated RFID reader similar to the RFID reader 18 described above. The integrated RFID reader permits the scanning terminal 24 to thereby read encoded data stored in RFID tags, such as RFID tag 30b. The handheld scanning terminal 24 processes the data read from the RFID tag 30b, and communicates the data to and from the network 12 as necessary. It should be appreciated that the handheld scanning terminal 24 may also be provided with an optical scanning capability, such as to read optical indicia including one and two-dimensional bar code symbols.

Referring now to FIG. 2, an exemplary RFID tag 30 is illustrated in greater detail. The RFID tag 30 corresponds to the RFID tags 30a-30b described above with respect to FIG. 1. More particularly, the RFID tag 30 includes an RF interface 34, control logic 36 and memory 38. The RF interface 34 is coupled to an antenna 32, and may include an RF receiver that recovers analog signals that are transmitted by an RFID reader, and an RF transmitter that sends data signals back to the RFID reader. The RF transmitter may further comprise a modulator adapted to backscatter modulate the impedance match with the antenna 32 in order to transmit data signals by reflecting a continuous wave (CW) signal provided by the RFID reader. The control logic 36 controls the functions of the RFID tag 30 in response to commands provided by the RFID reader that are embedded in the recovered RF signals. The control logic 36 accesses the memory 38 to read and/or write data therefrom. The control logic 36 also converts analog data signals recovered by the RF interface 34 into digital signals comprising the received commands, and converts digital data retrieved from the memory 38 into analog signals that are backscatter modulated by the RF interface 34. The RFID tag 30 may be adapted to derive electrical power from the interrogating signal provided by the RFID reader, or may include an internal power source (e.g., battery).

The memory 38 of the RFID tag 30 contains a space for data storage having plural fields that may be defined by an end user of the automated data collection system. In the present invention, at least one of the fields is predefined to include an address field. The address field defines a specific location on the Internet. For example, the address may comprise a Uniform Resource Locator (URL) used to identify a website hosted on a server connected to the Internet, such as the host server 14 or the remote server 44, that contains information or applications associated with the particular RFID tag 30. It should be appreciated that a URL embedded in an RFID tag may identify a location of a file or application that may exist anywhere within a single computer (such as including client computer 16), a wireless local area network (such as including scanning terminal 24), a local area or wide area network (such as including network 12 and host server 14), the Internet 42, or all other networks connected thereto.

As known in the art, a URL contains the protocol prefix, port number, domain name, subdirectory names and file name. Port addresses are generally defaults and are rarely specified. To access a home page on a web site, only the protocol and domain name are required. For example, the URL http://www.intermec.com retrieves the home page for the Intermec Technologies Corporation. The http:// part of the URL is the web protocol, and www.intermec.com is the domain name. If the page is stored in another directory, or if a page other than the home page is required, slashes are used to separate the names. For example, the URL http://www.intermec.com/products/rfid.htm points to the page describing Intermec's RFID products. There are other Internet protocols defined by URLs, including: (a) http:// which refers to a World Wide Web server; (b) ftp:// which refers to a File Transfer Protocol server; (c) news:// which refers to a Usenet newsgroup server; (d) mailto:// which refers to an e-mail server; (e) wais:// which refers to a Wide Area Information server; (f) gopher:// which refers to a Gopher server; (g) file:// which refers to a file stored on a local system; (h) telnet:// which refers to applications stored on a network server; (i) rlogin:// which refers to applications stored on a network server; and, (j) tn3270:// which refers to applications stored on a mainframe. The present invention anticipates that any of these types of URL's may be encoded on an RFID transponder for retrieval or use of specific information and applications. It is further anticipated that other types of URL's may be developed in the future to further define the locations of files as the use and scope of computer networks continues to evolve, and that all such URL's can be encoded into the memory of an RFID transponder in the manner described above. The .com portion of the domain name stands for the commercial top level domain category. There are other known top level domain categories, including .org for organization, .edu for educational and .gov for governmental.

Alternatively, the address may comprise an e-mail address used to identify a mailbox for an Internet user, such as a person or business, on the Internet. As known in the art, an e-mail address defines a location on a server that can receive and send e-mail messages. The e-mail messages can thereafter be retrieved by the user using an e-mail client application resident on a computer connected to the server. The format for addressing a message to an Internet user is USERNAME@DOMAIN NAME. For example, the address of the present inventor is Clark.Richter@intermec.com. There are no spaces between any of the words. Clark.Richter is the user name and intermec.com is the domain name (as described above with respect to URL's).

The relationship between the RFID tag 30 and the location defined by the Internet address can take numerous forms. If the address is a URL, the URL may identify the location of a Hypertext Markup Language (HTML) encoded document stored in a hypertext transfer protocol (HTTP) server somewhere on the Internet. The HTML-encoded document may comprise additional information regarding the item to which the RFID tag 30 is affixed. For example, the RFID tag 30 may be affixed to a particular object, such as a container of hazardous materials. By reading the RFID tag 30 with a browser-enabled RFID reader, such as the client computer 16 or scanning terminal 24 described above, the web site associated with the object can be retrieved and the HTML-encoded document associated with the URL displayed on the screen. In this example, the HTML-encoded document may include a detailed description of the contents of the container, the toxicity and/or radioactivity levels, clean-up requirements, disposal date, and other important information.

Alternatively, the HTML-encoded document may include an embedded Java-Applet that is executed automatically by a browser-enabled and Java-enabled RFID reader, such as the client computer 16 or scanning terminal 24 described above. For example, the RFID tag 30 may be included in a shipping label affixed to a package, and the web site may be uniquely associated with the particular package. At every stage of processing or shipment of the package, an RFID reader as described above interrogates the RFID tag 30. Upon accessing the web site, the embedded Java-Applet is executed by the client computer 16 or the scanning terminal 24, causing the web site to be updated with information regarding the package, e.g., location, arrival time/date, etc. A customer awaiting delivery of the package can also access the web site to thereby obtain current information regarding the status of the shipment.

If the Internet address is an e-mail address, the address may identify a user that has a relationship to the RFID tag 30. For example, the RFID tag 30 may be included in a shipping label affixed to a package, and the embedded e-mail address may correspond to the customer awaiting delivery of the package. At every stage of processing or shipment of the package, an RFID reader as described above interrogates the RFID tag 30. The RFID reader may then automatically communicate an e-mail message to the embedded address containing information regarding the package, e.g., location, arrival time/date, etc. A customer awaiting delivery of the package can retrieve these e-mail messages to thereby obtain current information regarding the status of the shipment.

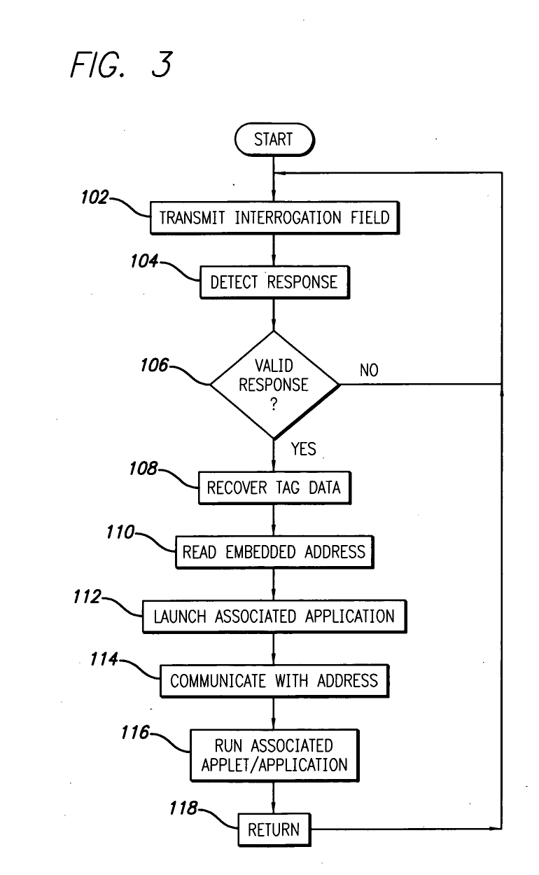

Referring now to FIG. 3, a flow chart illustrates operation of a client computer 16 or scanning terminal 24 in association with a connected or integrated RFID reader. The flow chart represents software instructions that are executed by the processor of the client computer 16 or scanning terminal 24 (referred to collectively as the processor). At step 102, the processor commands the RFID reader to transmit an interrogation field in order to communicate with an RFID tag 30. This may be responsive to a trigger command by an operator of a handheld device, or may be automatically generated by a fixed position RFID reader. At step 104, the processor attempts to detect a response from an RFID tag. It should be appreciated that the RFID reader would be in a transmit mode in step 102 and a receive mode in step 104. At step 106, a response signal is analyzed to determine whether it is a valid response from an RFID tag or a random RF noise signal. If the received signal is determined to be not valid, then the processor returns to step 102 and repeats the aforementioned steps.

Alternatively, if the received signal is determined to be valid, then the processor proceeds to step 108, and the processor attempts to recover the data stored in the RFID tag 30. At step 110, the processor reads the embedded address field to recover the Internet address data. Then, at step 112, the processor launches an appropriate application. If the address corresponds to a URL, and if the browser application is not already active on the desktop of the client computer 16 or scanning terminal 24, the processor launches the browser application. It is anticipated that certain devices may utilize a browser as a front-end application and may therefore be always in an active state. The recovered URL is then loaded into the address window of the browser application, causing the browser to generate a HTTP message communicated through the network 12 to the host server 14 to send a request for a web site with the given URL address (step 114). Unless the desired object associated with the URL address is resident on the host server 14, the host server 14 will route the HTTP message onto the Internet 42. The web site with the URL address may then respond by sending a HTTP message back to the browser application. The HTTP message may include an HTML-encoded document in the form of data packets that define graphical information to be displayed by the browser application. The HTML-encoded document is received and displayed by the browser application, thereby enabling the user to view the information corresponding to the RFID tag 30. Once the web site identified by the URL has been accessed, the processor runs the application or Java-applet associated with the web site (step 116). The operator of the client computer 16 or scanning terminal 24 may be prompted to enter information or data, such as identifying information, or the browser application may operate autonomously without requiring further interaction by the operator. Thereafter, at step 118, the processor returns to step 102 and is ready to read another RFID tag 30.

Alternatively, if the address corresponds to an e-mail address, and if the e-mail client is not already active on the desktop of the client computer 16 or scanning terminal 24, the processor launches the e-mail client (step 112). The e-mail client then formats an e-mail message containing data recovered from the RFID tag 30, or other data such as date, time, location, temperature, etc. The recovered e-mail address is then loaded into the address field of the e-mail message and the message is sent through the network 12 to the host server 14 (step 114). Unless the user associated with the e-mail address has a mailbox resident on the host server 14, the host server 14 will route the e-mail message onto the Internet 42 to the server hosting the domain name identified in the e-mail address. The operator of the client computer 16 or scanning terminal 24 may be prompted to enter information or data, such as identifying information, or the e-mail client may operate autonomously without requiring further interaction by the operator. Thereafter, at step 118, the processor returns to step 102 and is ready to read another RFID tag 30.

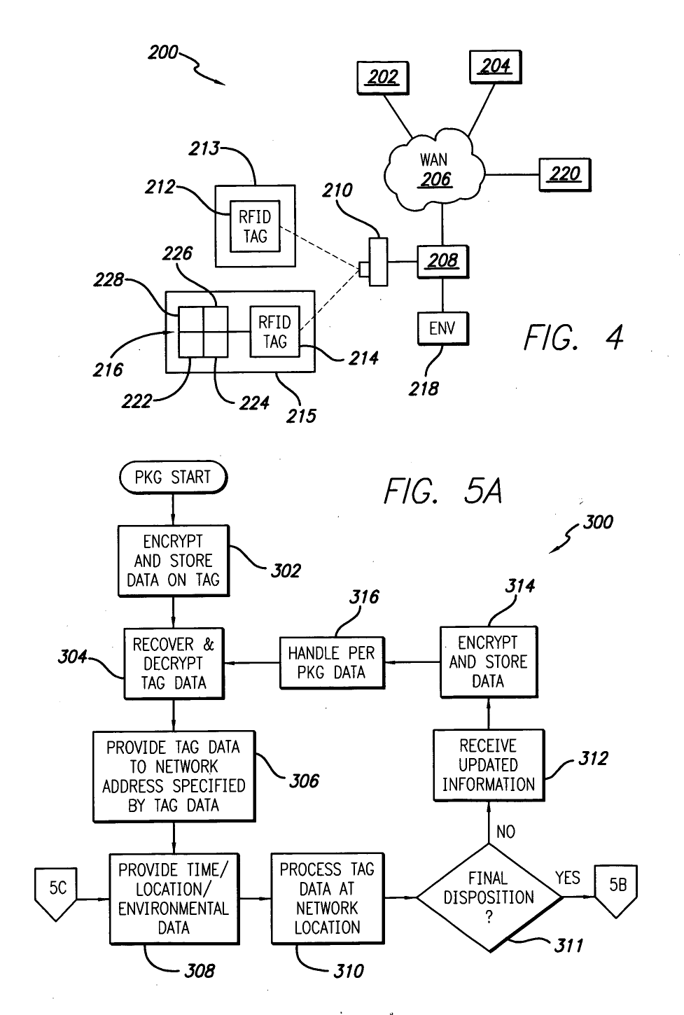

Advantageously, the invention provides an ability to operate two or more essentially separate, or partially separate, handling systems using a common network of RFID readers. FIG. 4 shows an exemplary system 200 of this type. System 200 may be useful for automatically reading RFID tags attached to packages in one or more supply chains, and communicating current information to one or more centralized data bases to improve total visibility of all assets available in the supply chain. Communication of information, for example, Item-Time-Location-Status (ITLS) information, may be accomplished without assistance from a user or operator. RFID readers in the system may automatically extract a data base or other network address from each RFID tags, and communicate ITLS or other information to the specified network address. ITLS or other tag-related information may be processed at the central data base or RFID-reader level, and new or modified information may be written to RFID tags in the system upon occurrence of defined events or at predetermined times.

System 200 may comprise a plurality of RFID interrogation stations 210 (one of many shown). Stations 210 may be distributed in various equipment and locations of a supply chain. For example, RFID readers may be installed at shipping and receiving docks, delivery and long-haul trucks, airplanes, ships, or other vehicles, transportation hubs, package sorting and routing equipment, warehouses, retail stores, and so forth. Readers may be attached to equipment or locales for communicating with RFID tags, or may be configured as portable devices carried by an operator to various locales. Each reader 210 may be connected to a computer 208 or other processor connected to a wide area network 206, for example, the Internet. In general, network and other data connections of system 200 may be made in any suitable manner, including but not limited to wired connections, wireless connections or a combination or wired and wireless connections.

One or more server, data processing, database, or other functional components 202, 204, 220 may also be connected to network 206. It should be appreciated that functions 202, 204, 220 may be provided as separate functions on a single computer, or may be distributed over any number of separate computers. In an embodiment of the invention, packages in the supply chain, e.g., package 213, are provided with an attached RFID tag 212 having a tag memory as described herein. As used herein, “package” refers generally to any unit or object being tracked through a supply chain, and is not limited to a wrapped or boxed parcel or other shipping container. For example, a pallet holding multiple different items may be considered a “package” in the sense used herein.

Each RFID tag may store one or more network addresses for one or more network locations 202, 204, 220. In an embodiment of the invention, multiple network addresses are written to an RFID tag for each package after the package enters the supply chain. Each address may be used to designate a different network address for performing a different function. For example, a first address may point to a location 202 operating an application and database for package tracking, a second location 204 may comprise a web page or other data file containing information for contents of package 213, such as Material Safety Data Sheet (MSDS) information, a Bill of Lading, customs forms, shipping address, environmental requirements, product specifications, or any other information of interest relating to the package, and a third location 220 may comprise an electronic payment or billing address. Any desired number of different network addresses may be stored using one or more RFID tags 212 on a package 213.

In an alternative embodiment, an RFID tag 212 may hold a single address for a network location 202. Network location 202 may include a database or similar function for providing additional information about the package from the same or different network locations. For example, location 202 may include a package tracking application, and may reference a second location 204 containing product data for items in the package, and a third location 220 for electronic billing or payment. Any desired combination of network addresses stored on the RFID chip or at a first network address may be used. It is believed advantageous to store at least one network address on a package-tracking RFID tag for a package tracking application.

Because system 200 may thus be designed to relate every package in the supply chain to at least one network address, it should be possible to operate multiple independent supply chains or tracking systems using the same network. Packages in each supply chain may simply be configured with a network tracking address for the chain. The RFID readers may be configured so as to interact with RFID tags using a standard protocol, and pass standard ITLS or other information to the network location designated by each tag. A supply chain tracking system may then be implemented by setting up a centralized tracking application at the designated network address. In this manner, different chains may share the RFID reader infrastructure associated with a supply chain, thereby spreading system overhead over a greater number of packages.

System 200 may further be configured to perform monitoring of environmental exposure for each package, or for selected packages. This may be useful, for example, if goods in transit are susceptible to damage from extremes of temperature or shock. In an embodiment of the invention, selected packages such as package 215 may be equipped with an RFID tag 214 connected to an environmental monitoring module 216. Module 216 may comprise a sensor 222 connected to sensor control and input/output circuit 224. Sensor 222 may comprise any desired environmental sensor, for example a thermistor, accelerometer, gas, fluid, or chemical sensor. Module 216 may comprise a disposable element, for example a low-cost integrated circuit device. In the alternative, module 216 may be configured as a reusable module that connects to RFID tag 214 via a removable connection, and that is removed when a package leaves the supply chain or when environmental monitoring is no longer desired.

Circuit 224 may be configured to receive and process signals from the sensor, and to provide a digital or analog signal indicative of the measured environmental factor to the RFID tag 214 or to an optional measurement control circuit 226. Measurement control circuit 226 may comprise a programmable controller or logic device configured to receive raw measurement data from sensor circuit 224, process the raw data according to a defined algorithm, and pass the processed data or a corresponding alert signal to the RFID tag 214, to a memory 228, or to a network location in the tracking system 200.

Various algorithms may be used to process environmental data. Conversion and calibration algorithms may be used to acquire accurate data in desired units of measure. Data logging routines may be used to acquire and store measurement data at defined time intervals. A screening routine may be used to screen measurement data and take specified action if data satisfies predetermined criteria. For example, if temperature exceeds a threshold for a specified period, a state indicator may be set to indicate overexposure, or a degree of overexposure to extreme temperatures. Likewise, cumulative environmental data may be calculated and stored, such as a time-temperature integral. The integral may be periodically recalculated and only the most current value stored, optionally with a date/time stamp, thereby minimizing memory requirements while still maintaining a record of environmental exposure.

One of the advantages of the invention is that environmental monitoring may be performed for packages in transit, without the need to attach a portable environmental monitoring module 216 to each package. To accomplish this, there need only be an environmental module located somewhere in the same environment as the package for which monitoring is to be performed. Thus, a static environmental monitoring module 218 may be located in the same warehouse, transit container, shipping dock, or other as the package. For example, an environmental monitoring module 218 may be connected to a processor 208 and RFID interrogation station 210 in a location such as a transit container or warehouse.

Control of the module 218 and processing of measurement data may be performed by computer 208 or by a component of module 218, as previously described. Interrogator 210 may periodically broadcast environmental monitoring data to packages within range. It should be apparent that antennas connected to interrogator 210 and monitor 218 may be disposed to cover an entire area of concern, such as a section of a warehouse or the interior of a transit compartment. RFID tags 212, 214 may be configured to receive and store environmental data from a remote sensing module 218, and may be configured to accumulate such data as they progress through a supply chain to provide a complete environmental history. In the alternative, or in addition, portable environmental monitors associated with a packages, such as module 216, may provided with monitoring data that is transmitted by tag 214 to an interrogator 210, and then re-broadcast to other packages in the vicinity, such as to RFID tag 212 on package 213.

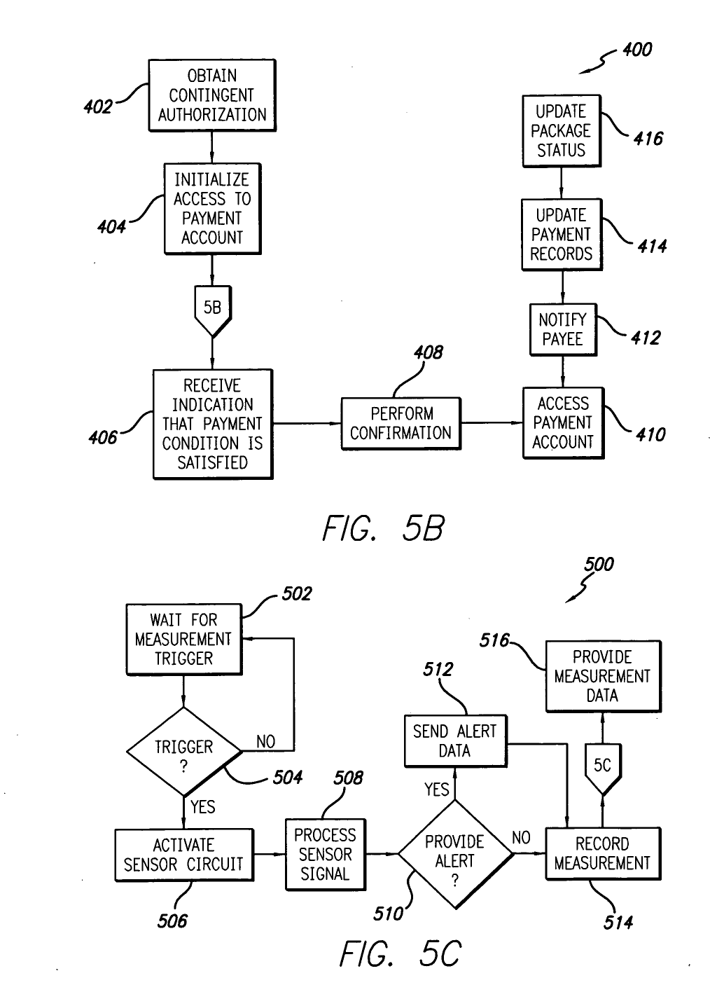

FIG. 5A shows exemplary steps of a method 300 for operating a supply chain tracking system to track a package equipped with an RFID tag. When a package enters the supply chain, it should be attached to or otherwise associated with a particular RFID tag of any suitable type. At step 302, identification data may be encrypted and stored on the RFID tag. An asynchronous encryption algorithm may be used as known in the art, with the private key maintained at a suitable secure network location such as a tracking hub or on the RFID tag. As disclosed herein, identification data should comprise a network address for a tracking application or database, and a package identifier sufficient to identify the particular package, such as a serial number. Further data may be stored on the RFID tag, or may be stored elsewhere in the system such as on a network-connected database. In the alternative, identification may be stored in decrypted form, enabling access by non-secure readers, which may be advantageous for open, multi-use tracking environments. In such embodiments, sensitive data should be securely maintained at a network location with a bare minimum of identification data stored on the RFID tag.

At step 304, RFID data is recovered and decrypted, or merely recovered if not encrypted, when the package passes an RFID reader/interrogator of the supply chain. Suitable methods of interrogating an RFID tag and decrypting data are known in the art. At step 306, a system processor connected to the interrogator provides stored identification data to a network address recovered from the tag. At step 308, the same processor may provide time, location, environmental, or other package status data to the recovered network address. For example, a time and location stamp may be added by a processor local to the interrogator, or chain-of-custody information. Data provided to the network location may be in encrypted or unencrypted form. Various suitable methods may be used to communicate with recovered network locations, including but not limited to email, ftp, streaming data, communication modules and protocols defined in network-compatible languages such as JAVA, or proprietary communication protocols. Environmental data may be recovered or obtained by any suitable method, including but not limited to method 500 described below in connection with FIG. 5C.

Referring to FIG. 5A at step 310, the data received from the local processor, including both package identification and status data, may be processed by a system processor addressed via the defined network address stored on the RFID tag. In an embodiment of the invention, package status data is added to a record in a package tracking database. Other functions may also be performed. For example, if package status indicates a delay or other problem, a suitable alert may be automatically prepared and provided to the package account holder. For further example, a message may be automatically prepared to a carrier or other entity later in a planned chain-of-custody, to alert them that the package is coming and inform them of any special package requirements.

The system processor may further determine whether the package has been finally disposed of, as indicated at step 311. Final dispositions may include, for example, received at the destination, accepted by the addressee, refused by addressee, damaged in transit, and so forth. The system may then determine an appropriate action to take. For example, when a package is accepted by the addressee, this may be deemed a “final disposition” that may trigger other actions such as collecting payment. An exemplary method 400 for automatically collecting payment for a package shipped is shown in FIG. 5B. It should be appreciated that method 400 or other automatic payment method may be performed at any time, and not just when a package is accepted by an addressee.

Referring again to FIG. 5A, at step 312 any updated information concerning the package may be received. For example, if the recipient changes the desired ship-to address while the package is in transit, the system may calculate another shipping route and update the package data accordingly. Such information, i.e., destination and route information, may be stored at any suitable system storage location. Updated information may be stored on the RFID tag or in a system database. In embodiments of the invention, certain package information may be stored only in a system database to minimize memory required on the tag. Using a system as described herein, package information in a system database may be accessed at any time by interrogating the RFID tag to obtain the network address via which the package data may be accessed.

At step 316, each package is routed or handled according to specified requirements stored on the tag or in a system database record. Handling may be performed in an automated or semi-automated fashion using robotic package handling equipment connected to the supply chain system. In the alternative, or in addition, human operators may be instructed to manually handle, store, or route packages according instructions provided when an RFID tag is read by an interrogation device. A large plurality of RFID-tagged packages may thus be routed and handled through a supply chain.

FIG. 5B shows exemplary steps of a method 400 for performing a payment transaction for a package in a supply network as described herein. The illustrated steps may be performed by a system computing component connected to a wide area network and configured to perform financial steps as shown. Initially, contingent authorization for electronic payment should be obtained, as shown at step 402. For example, a shipping entity and a receiving entity may execute a contract authorizing electronic payment once certain conditions of shipment have been satisfied. Conditions may include, for example, delivery & acceptance, initial pick-up, clearing of customs, or any other specified event. Account information, for example a correspondence address and one or more client account numbers, may also be obtained or associated with the client authorizing payment. At step 404, access to an electronic payment account is initialized. For example, a credit card account number, a bank account number, or other financial account number may be provided by the entity that is to pay shipping costs. At this point, the payment method may wait for the payment condition to be satisfied.

At step 406, the payment component may receive an indication that a payment condition has been satisfied. For example, after a package has been accepted by an addressee, a delivery person may upload the package ID with an “accepted” status to a designated network location for tracking software. The tracking software may then alert a payment module and provide transaction details, including an amount due. Optionally, at step 408, the payment module may obtain an independent confirmation of package status. However, in many embodiments it is believed that the system should provide sufficiently reliable information so as to obviate a need for independent verification.

At step 410, the payment account may be accessed using the previously-supplied account access information, and debited for the amount due. One of ordinary skill may select a suitable method for accessing a payment account and obtaining an electronic payment, as known in the art. At step 414, the payment module may update its own records to indicate that payment has been obtained. At step 416, the payment module may provide a message to other system components, for example a package tracking module, that payment has been successfully obtained. Payment status information may be updated at the package level, i.e., on an RFID tag attached to the package, as well.

It should be appreciated that a similar process may be followed for billing of shipping clients, if the entity that will pay for the shipping can not or will not authorize electronic payment, or for any other reason. In such case, step 404 may be omitted and billing details may be determined at step 402, for example a billing address, billing procedure and account number. At step 410, the predetermined billing procedure may be implemented, including automatically generating an invoice or bill, and providing it to a designated address, such as an electronic mail address. Subsequently, collection of issued bills and invoices may be performed in any desired manner.

FIG. 5C shows exemplary steps of a method 500 for performing environmental monitoring in conjunction with an RFID tag-equipped supply chain. Suitable configurations of environmental sensing components have already been described. Generally, sensing may be performed continuously, or in response to a chronological or other trigger. For portable sensors, and particularly for small sensors attached to packages, it may be advantages to limit monitoring to specific events so as to reduce memory and power requirements. Suitable triggers may include, for example, expiration of a particular time interval, the presence of an interrogation signal, or other external trigger. At steps 502 and 504, the system waits for a trigger event before initiating a sensor circuit. When the trigger is satisfied—for example, a clock may indicate that a particular time period has passed since the last measurement—then the sensor circuit may be activated as indicated at step 506.

Activation of the sensor circuit causes a sensor signal output to be available on a signal processor input. At step 508, the signal processor processes the signal data according to a defined algorithm. Examples of algorithms that may be employed have been described hereinabove. After processing, it may be determined that an environmental condition has occurred requiring an alert to be generated, as indicated at step 510. For example, cumulative data may indicate that a package has been exposed to a temperature above a defined threshold for too long a period of time. If conditions for an alert are satisfied, an alert signal may be sent as indicated at step 512. For example, an environmental status variable in an RFID tag may be set to a value indicating an alert. Next time the package is in an interrogation field, the alert status will be recovered and provided to the network location specified by the RFID tag.

At step 514, sensor data may be recorded in any storage media interoperable with a communication network for the system. In an embodiment of the invention, sensor data is stored for at least an interim period between interrogation events in an RFID tag memory or other portable device memory connected to the RFID tag. When the tag is interrogated, the stored data may be uploaded to a system database and the portable memory made available for storage of new data. In the alternative, or in addition, environmental data may be stored in a system component without using an RFID tag or other portable memory device associated with individual packages. However, it should be advantageous to store at least an environmental state variable or other indicator of environmental data kept in another system location on the RFID tag itself, if only as an independent confirmation.

When the package RFID tag is interrogated, package status, including environmental measurement data or processed environmental data may be provided to the RFID tag and from there to the RFID interrogator. In the alternative, environmental data may be maintained in a network location and updated with ITLS information from an RFID interrogator as appropriate. For example, data from a static environmental module may be collected only when the ITLS information for a package indicates it is in the vicinity of the environmental module. When the ITLS information indicates that the package has been relocated, data collection from the first environmental module may cease and if available, data may be collected from a different sensing module in the now package location.

Having thus described a preferred embodiment of an RFID tag having an embedded uniform resource locator and its application in a supply network, it should be apparent to those skilled in the art that certain advantages of the aforementioned invention have been achieved. It should also be appreciated that various modifications, adaptations, and alternative embodiments thereof may be made within the scope and spirit of the present invention. The invention is further defined by the following claims.

What is claimed is:

1. A method for using information from an RFID tag and from a computer network location, wherein the RFID tag is located on a package passing through a supply chain to a destination, the method comprising:
interrogating the RFID tag located on the package;
receiving first information stored in a memory of the RFID tag, the first information including an address identifying a location on a computer network and first data regarding the package;
communicating with the location identified by the address;
accessing second information from the location on the computer network, the second information including second data regarding the package; and
updating the second information at the location on the computer network to reflect the first data regarding the package.

2. The method of claim 1, wherein the accessing step comprises accessing the second data comprising a description of contents of the package.

3. The method of claim 2, wherein the accessing step comprises accessing the detailed description comprising a document descriptive of the contents, the document selected from the group consisting of: a material safety document, a bill of lading, an environmental requirements document, and a customs document.

4. The method of claim 1, wherein the receiving step further comprises receiving the first information comprising the address, the address comprising a Uniform Resource Locator for the location.

5. The method of claim 4, wherein the updating step further comprises updating the second information with the first data by executing an application distributed from the location during the communicating step.

6. The method of claim 1, wherein the updating step further comprises updating the first data with a status parameter for the package selected from the group consisting of: a current location parameter, a current time parameter, a current date parameter, and a current custody parameter.

7. The method of claim 1, wherein the receiving step further comprises receiving the first information comprising an address, the address comprising an e-mail address.

8. The method of claim 7, further comprising sending an e-mail message with at least a portion of the first data regarding the package to the e-mail address.

9. The method of claim 8, further comprising including a status parameter for the package in the first data, the parameter selected from the group consisting of: a current location parameter, a current time parameter, a current date parameter, and a current custody parameter.

10. The method of claim 1, wherein the receiving step further comprises receiving the first information comprising an encryption key.

11. The method of claim 10, wherein the receiving step further comprises receiving the encryption key comprising a private key of a private/public key pair.

12. The method of claim 10, further comprising decrypting the first information using the encryption key.

13. The method of claim 1, further comprising, after the communicating step, providing third information to the RFID tag, the third information received from the network location.

14. The method of claim 13, further comprising commanding the RFID tag to replace at least a portion of the first information with the third information in the RFID memory.

15. The method of claim 13, further comprising commanding the RFID tag to store the third information in the RFID memory.

16. The method of claim 13, further comprising commanding the RFID tag to merge the third information with the first information in the RFID memory.

17. The method of claim 13, wherein the providing step further comprises providing the third information comprising a new destination address for the package.

18. The method of claim 1, further comprising processing at least one of the first information and the second information to determine whether a defined condition is satisfied.

19. The method of claim 17, further comprising automatically notifying a designated party if the defined condition is satisfied.

20. The method of claim 19, wherein the notifying step further comprises notifying the designated party comprising a designated payer for the package, and wherein the defined condition comprises delivery of the package.

21. The method of claim 20, wherein the notifying step further comprises automatically providing an invoice to the designated payer.

22. The method of claim 20, further comprising automatically collecting an electronic payment from the designated payer.

23. The method of claim 19, wherein the notifying step further comprises notifying the designated party comprising a third-party authority, and wherein the defined condition comprises an alert of interest to the authority.

24. The method of claim 23, wherein the notifying step further comprises notifying the third-party authority of the alert of interest, wherein the alert of interest is selected from the group consisting of: an environmental alert, a customs alert, a spill alert, a release event alert, a spoilage alert, a security alert, and a radiation alert.

25. The method of claim 1, wherein the receiving step further comprises receiving the first information comprising the address, the address comprising a Uniform Resource Locator for the location.

26. The method of claim 1, wherein the receiving step further comprises receiving the first information comprising environmental exposure data indicative of output from at least one environmental sensor located in a vicinity of the package during at least a portion of a period of time in which the package is passing through the supply chain.

27. The method of claim 26, further comprising receiving the output from the at least one environmental sensor and processing the output to obtain the environmental exposure data.

28. The method of claim 1, wherein the accessing step further comprises accessing the second information comprising environmental exposure data indicative of output from at least one environmental sensor located in a vicinity of the package during at least a portion of a period of time in which the package is passing through the supply chain.

29. The method of claim 28, further comprising receiving the output from the at least one environmental sensor and processing the output to obtain the environmental exposure data.

30. A radio frequency identification (RFID) tag comprising:
a memory having a data storage area;
an RF interface coupled to the memory for communicating data between the memory and an external interrogator, the memory including a data field containing an address identifying a location on a computer network corresponding to the RFID tag.

31. The RFID tag of claim 30, wherein the address further comprises a Uniform Resource Locator.

32. The RFID tag of claim 30, wherein the memory further contains a key for use in asynchronous encryption and decryption.

33. The RFID tag of claim 30, wherein the memory further contains a private key for use in asynchronous encryption and decryption.

34. The RFID tag of claim 30, wherein the memory further contains environmental exposure data indicative of output from at least one environmental sensor.

35. A method for controlling disposition of a package passing through a supply chain to a destination, using an RFID tag located on the package and at least one RFID interrogator at a supply chain location, the method comprising:
interrogating the RFID tag located on the package;
receiving first information stored in a memory of the RFID tag, the first information regarding the package;
accessing second information from a computer network operatively associated with the supply chain, the second information relating to the package; and
providing at least a portion of the second information to the RFID tag using the at least one RFID interrogator.

36. The method of claim 35, further comprising commanding the RFID tag to replace at least a portion of the first information with the second information in the RFID memory.

37. The method of claim 35, further comprising commanding the RFID tag to store the second information in the RFID memory.

38. The method of claim 35, further comprising commanding the RFID tag to merge the second information with the first information in the RFID memory.

39. The method of claim 35, wherein the providing step further comprises providing the second information comprising a new destination for the package.

40. The method of claim 39, further comprising routing the package towards the new destination, wherein the new destination replaces an old destination.

41. A method for providing a status alert for a package passing through a supply chain to a destination, using an RFID tag located on the package and at least one RFID interrogator at a supply chain location, the method comprising:
interrogating the RFID tag located on the package;
receiving first information stored in a memory of the RFID tag, the first information regarding the package;
accessing second information from a computer network operatively associated with the supply chain, the second information relating to the package; and
processing at least one of the first information and the second information to determine whether a defined condition is satisfied.

42. The method of claim 41, further comprising automatically notifying a designated party if the defined condition is satisfied.

43. The method of claim 41, wherein the notifying step further comprises notifying the designated party comprising a designated payer for the package, and wherein the defined condition comprises delivery of the package.

44. The method of claim 43, wherein the notifying step further comprises automatically providing an invoice to the designated payer.

45. The method of claim 43, further comprising automatically collecting an electronic payment from the designated payer.

46. The method of claim 42, wherein the notifying step further comprises notifying the designated party comprising a third-party authority, and wherein the defined condition comprises an alert of interest to the authority.

47. The method of claim 46, wherein the notifying step further comprises notifying the third-party authority of the alert of interest, wherein the alert of interest is selected from the group consisting of: an environmental alert, a customs alert, a spill alert, a release event alert, a spoilage alert, a security alert, and a radiation alert.

48. A method for tracking environmental exposure of a package passing through a supply chain to a destination, using an RFID tag located on the package, the method comprising:
receiving output from at least one environmental sensor disposed in a vicinity of the package during at least a portion of a period of time in which the package is passing through the supply chain;
processing the output to obtain environmental exposure data; and
storing the environmental exposure data in at least one location selected from an RFID tag memory located on the package and another memory location not located on the package that is associated with the package using an identifier maintained in the RFID tag memory.

49. The method of claim 48, wherein the storing step comprises storing at least a portion of the environmental exposure data in the RFID tag memory.

50. The method of claim 49, further comprising interrogating the RFID tag to obtain the environmental exposure data.

51. The method of claim 49, further comprising receiving second output from a second environmental sensor disposed in a different vicinity of the package during at least a portion of a period of time in which the package is passing through the supply chain and processing the second output to obtain second environmental exposure data.

52. The method of claim 51, further comprising combining the first environmental exposure data and the second environmental exposure data to obtain cumulative environmental exposure data indicative of a cumulative exposure of the package to an environmental factor.

53. The method of claim 48, wherein the receiving step comprises receiving the output from at least one environmental sensor selected from: temperature measurement output, humidity measurement output, acceleration measurement output, and chemical measurement output.

54. The method of claim 48, further comprising evaluating the environmental exposure data, and alerting a designated party if the exposure data indicates that the package has been exposed to an environmental factor in excess of a defined threshold.
